(19) United States
(12) Patent Application Publication
(10) Pub. No.: US 2010/0082419 A1
(43) Pub. Date: Apr. 1, 2010

(54) SYSTEMS AND METHODS OF RATING AN OFFER FOR A PRODUCTS

(76) Inventors: David Hsueh-Chi Au-Yeung, Scarborough (CA); Matthew Cheung, Misissauga (CA); Wehuns Tan, Oakville (CA); David Christopher Earl Meyers, Mississauga (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/243,476

(22) Filed: Oct. 1, 2008

(51) Int. Cl. G06Q 30/00

(52) U.S. Cl. 705/14.19; 705/1; 705/14.41

(57) ABSTRACT

Embodiments disclosed herein relate generally to systems and methods for rating an offer for a product. In one broad aspect there is provided a method for rating an offer for a product. The method includes generating a component score for each rating component of a plurality of rating components. The rating components include at least one community feedback component and at least one intrinsic component. Each rating component is then assigned a weight, where the weight assigned to the at least one community feedback component is proportional to the volume of community feedback and the weight assigned to the at least one intrinsic community feedback is inversely proportional to the volume of community feedback. In another broad aspect, there is provided a method for rating an offer for a product. The method includes generating a component score for each rating component of a plurality of rating components. The plurality of rating components include a price of the offer. The step of generating the component score for the price of the offer includes comparing the price of the offer to a current market price reference for the product. The current market price reference is based on community feedback associated with the offer.

### TECHNICAL FIELD

The described embodiments relate to methods and systems for rating an offer for a product. More particularly, the described embodiments relate to systems and methods for rating an offer for goods and/or services where the rating is at least partially based on community feedback information associated with the offer.

### BACKGROUND

One of the most important problems a consumer faces when making a purchase decision for goods or services is determining whether a certain offer is of a good value, and whether this offer represents the best available offer across a range of products. Despite the wealth of information available to the consumer today, this question is deceptively difficult due to the number of variables involved, individual preferences and the potential for a conflict of interest between groups.

Various solutions exist today in an attempt to address this problem. The most rudimentary involves the human “personal shopper”. Another common system involves price comparison with regular retail price (i.e. 30% off, or save $140). Yet other systems use a community rating approach where users can explicitly rate an offer up or down.

However, these existing systems have various shortcomings. Specifically, the human system is reliable, but is costly and cannot scale to a large number of products. The price comparison approach is flawed where the “regular” retail price for the item does not represent the nominal market price of the item. Furthermore, the community approach works well only when the number of raters is large. For all but the most popular products, achieving the critical mass of feedback is not often practical in a reasonable amount of time.

### SUMMARY

Embodiments disclosed herein relate generally to systems and methods for rating an offer for a product.

In one broad aspect, there is provided a method for rating an offer for a product. The method comprises: (a) receiving the offer from a source; (b) obtaining community feedback associated with the offer; (c) generating a component score for each rating component of a plurality of rating components, the plurality of rating components comprising at least one intrinsic component and at least one community feedback component; (d) assigning a weight to each of the plurality of rating components, the weight assigned to the at least one community feedback component being proportional to the volume of community feedback and the weight assigned to the at least one intrinsic component being inversely proportional to the volume of community feedback; (e) applying the weight of one of the rating components to the corresponding component score to generate a weighted component score; (f) repeating step (e) for a least a portion of the plurality of rating components; and (g) generating a total rating score based on the weighted component scores.

### BRIEF DESCRIPTION OF THE DRAWINGS

For a better understanding of embodiments of the systems and methods described herein, and to show more clearly how they may be carried into effect, reference will be made, by way of example, to the accompanying drawings in which:

FIG. 1 is a block diagram of a system for rating an offer for a product according to an embodiment of the present invention;

FIG. 2 is a block diagram of the rating module of FIG. 1 according to an embodiment of the present invention;

FIG. 3 is a flowchart of the steps of a method for rating an offer for a product according to an embodiment of the present invention;

FIG. 4 is a flowchart of the steps of generating component scores for a plurality of rating components according to an embodiment of the present invention;

FIG. 5 is a flowchart of the steps of generating a components score for the price of the offer according to an embodiment of the present invention; and

FIG. 6 is a flowchart of the steps of adjusting the total rating score based on similar offers according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

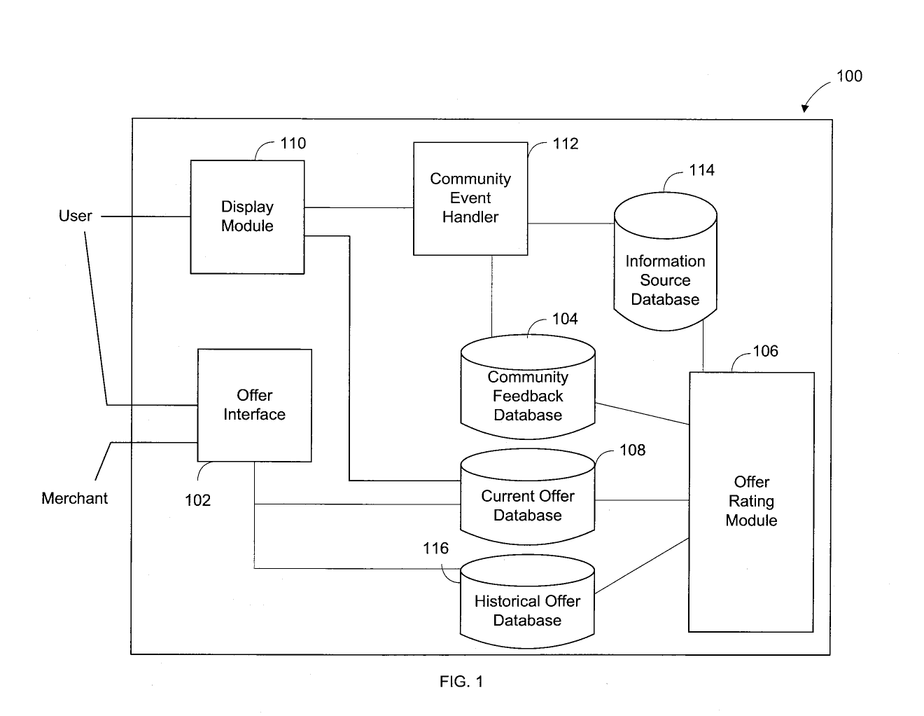

Reference is now made to FIG. 1, in which an exemplary embodiment of a system 100 for rating an offer for a product is illustrated. As used herein, the term “product” includes goods and services. The system includes an offer interface 102 for receiving offers for products, a community feedback database 104 for storing community feedback information associated with the offers, and a offer rating module 106 for generating a rating score for each offer based on the community feedback information.

The offer interface 102 may be any viable interface that allows an offer to be input into the system 100 manually by a user or operator, and/or automatically by an electronic transfer or the like. An offer typically includes a price and/or discount and a product or products to which the offer is associated. In an exemplary embodiment the offer interface 102 may be an interactive web application that allows a user or operator to manually input an offer. The interactive web application may be provided on any standard web hosting environment and is typically accessible by a standard web browser such as Windows™ Internet Explorer™ or Firefox™. The web hosting environment may be a single application server or a cluster of application servers based preferably on the size of the system 100.

In other cases the offer interface 102 may be a feed processing system that allows offers to be automatically input into the system 100. The feed processing system may include a feed processor server or servers with multiple data feeds that receive electronic offer data from merchants or other machine readable sources.

In some embodiments, the system 100 further includes a current offer database 108 for storing the offers received by the offer interface 102. The current offer database 108 may be implemented on any known database server, such as an SQL server. The current offer database 108 may have a single record for each offer which links the offer with the price and/or discount and the product or products to which it applies.

The community feedback database 104 is used to store community feedback events where each community feedback event is related to a particular offer. Community feedback is information received from users of the rating system 100 that indicates the quality of an offer. Community feedback is extremely important in rating a product offer since humans are typically far superior to fixed algorithms at recognizing patterns (a good offer can be considered a form of pattern) and are generally accurate in aggregate.

Community feedback can be either explicit or implicit. Explicit community feedback refers to direct feedback that a user provides with respect to an offer. Explicit community feedback includes, but is not limited to, explicit user rating and flagging of the offer. User rating refers to the user giving the offer an explicit rating that indicates whether the user believes the offer is “good” or “bad”. Flagging refers to users providing more specific feedback such as specifying that the offer is inappropriate, unavailable, a duplicate or the best of.

Explicit feedback is simple and direct, but is prone to abuse and requires user action that may not directly align with the user's task or objective at hand. Implicit feedback, on the other hand, is indirect feedback that is gleaned from typical interactions the user has with the system 100. Typical interactions can be categorized as either negative or positive. A positive interaction is associated with a valid and valuable offer, while a negative interaction is associated with an invalid or undesirable offer. Such typical interactions may include, but are not limited to, clicking through an advertisement for the offer, bookmarking the offer webpage, sending the offer webpage to a friend, or the amount of time spent interacting on the offer webpage. Clicking through an advertisement is the process of clicking through an online advertisement to the advertiser's website or webpage. The click-through rate (CTR) measures the amount of times an advertisement is clicked versus the amount of time it is viewed and is often used as an indicator of the success of the advertisement.

Not all community feedback events are equal. Accordingly a base weight may be assigned to each community feedback event. Typically the higher the weight, the more reliable the community feedback event.

In some embodiments, the system may also include a display module 110 and a community feedback handler 112 which together generate and update the community feedback event data stored in the community feedback database 104. The display module 110 provides a means by which a user of the system 100 can interact with the system. In some embodiments, the display module 110 displays the offer and its associated total rating score. Users of the system 100 can interact with the display module 110 and their actions and behavior may be monitored. When a designated community feedback event occurs the community feedback event is sent to the community event handler 112.

The community event handler 112 preferably receives community feedback events detected by the display module 112, looks up the base weight assigned to the community feedback event, and then stores the community feedback event and its associated base weight in the community feedback database 104. Where the community feedback events consist of both implicit and explicit community feedback events, the community event handler 112 may periodically adjust the base weight of the implicit community feedback events by correlating the implicit community feedback events with the explicit community feedback events. The strength of the correlation and the frequency of the occurrence of a particular implicit community feedback event will preferably increase the base weight assigned to that particular community feedback event.

In some embodiments, the system 100 may further include one or both of an information source database 114 and a historical offer database 116. The information source database 114 stores information about the source or submitter of the offer. Specifically, each source is associated with a number of variables or factors that indicate reliability. These variables are stored in the information source database 114.

In some cases, when a new offer is input into the system 100 via the offer interface 102, the offer is sent to the information source database 114. The information source database 114 then determines if the source of the offer is new. If it is, a new offer source object or record is created in the information source database 114 with a reliability value that is based upon the best perceived level of reliability depending on the category of the new source. If the category is unknown, a default value will be chosen. If the source is known then the offer source object or record will be updated to indicate that the source has submitted a new offer.

From that point on, the reliability of the source is preferably updated each time the community event handler 112 receives a community feedback event related to an offer from that source.

The historical offer database 116 stores information about past offers. Where the system includes a historical offer database 116, each time a new offer is received a copy of the offer is stored in the historical offer database 116.

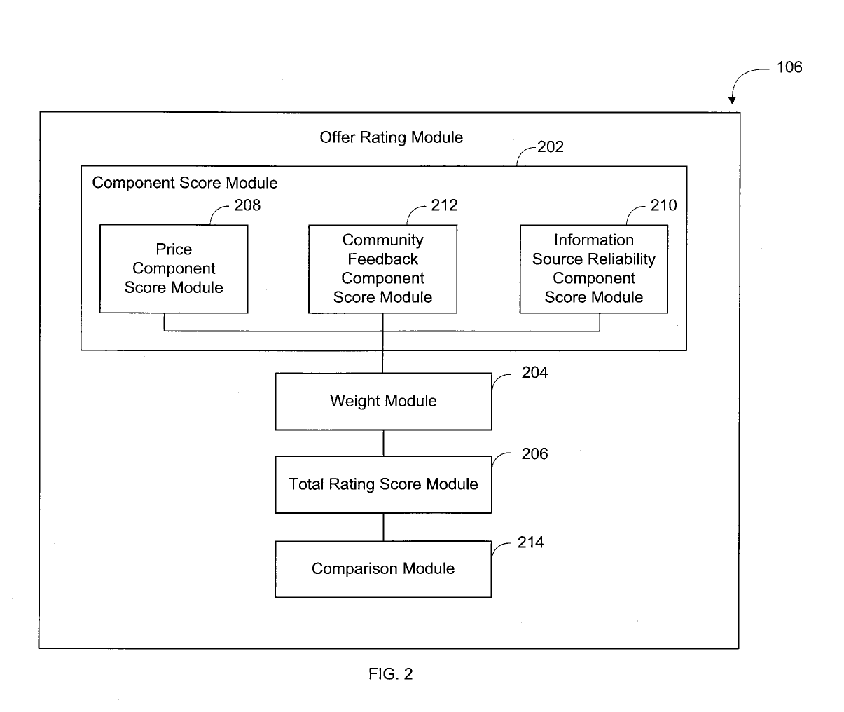

The offer rating module 106 generates a total rating score for each offer based on the offer itself and the community feedback related to the offer. In some embodiments, the total rating score is also based on the information in the historical database 116 and the information source database 114. Where the system 100 includes a current offer database 108 and a historical offer database 116, the offer rating module 106 may record the total rating score in these databases. Generally a higher rating score indicates a better or higher quality offer. The operation of the offer rating module 106 will be described in further detail in reference to FIG. 2.

Reference is now made to FIG. 2, which illustrates an exemplary embodiment of the offer rating module 106 of FIG. 1. The offer rating module 106 includes a component score module 202 for generating a component score for each rating component, a weight module 204 for assigning a weight to each of the rating components, and a total rating score module 206 for applying the weight of each of the rating components to the corresponding component score and generating a total rating score for the offer based on the weighted component scores.

The component score module 202 generates an individual component score for each rating component or factor. Typically, at least one intrinsic rating component and at least one community feedback component is used to generate the total rating score for a particular offer. However, any other suitable combination of intrinsic and community feedback components may be used to generate the total rating score for the particular offer. An intrinsic rating component is one that relates only to the offer itself and the market conditions surrounding the offer. Generally, intrinsic components are immediately available upon creation of the offer. Intrinsic rating components may include, but are not limited to, the price of the offer and the reliability of the source of the offer. Community feedback components, on the other hand, are components that are based on the reaction of customers to the offer. Generally the effectiveness of a community feedback component in indicating the value or quality of an offer is based on the volume or amount of community feedback. The more community feedback relating to the particular offer, the better an indicator the community feedback component will be as to the value or quality of the offer.

In one embodiment, the rating components include the price of the offer, the reliability of the source of the offer, and community feedback. In this embodiment, the component score module 202 comprises a price component score module 208, an information source reliability component score module 210, and a community feedback component score module 212.

The price component score module 208 generates a component score for the price of the offer. Preferably, the component score for the price of the offer is not solely generated by comparing the price of the offer to the manufacturer's suggested retail price (MSRP) or the retail price. In contrast, the component score for the price of the offer is preferably generated by the price component score module 208 by comparing the price of the offer to: (i) a current market price reference; (ii) one or more future market price references; or (iii) both a current market price reference and one or more future market price references. Comparing the price of the offer to a realistic market price reference instead of solely to the MSRP or the retail price greatly increases the reliability of the comparison. Specifically, the market price reference takes into account the volatility of the price of the product. For example, a market price reference comparison will identify that a small discount on a product with a very stable price is a better deal than a moderate discount on a product in which the price varies greatly.

The current market price reference may be generated from the offers currently available for the product and from past offers for the product and similar products. For example, the current market price reference may be based on the following information: the prices of past-completed transactions for the same or similar product; the average lowest available price for the product in the past; and the current lowest available price for the product.

In some cases, the current market price reference may be augmented by community feedback information. For example, the system 100 may permit users or consumers to input their opinion on what a fair price for the product is. This data can be used in aggregate with the others factors to determine the current market price reference.

Once the price component score module 208 has generated a current market price reference, the price component score module 208 calculates a current price score. A current price score is a numerical representation of the difference between the price of the offer and the current market price reference. In one embodiment, the current price score is calculated by determining the difference between the price of the offer and the current market price reference, then adjusting the difference to account for the volatility of the price, and then converting the adjusted difference to standard deviation units. Specifically, the difference may be adjusted to account for the volatility of the price of the product according to formula (1) shown below.

$$current price SD = \frac{\begin{matrix}offer price - \\ current market price reference\end{matrix}}{SD of price of the product in the past} \qquad ( 1 )$$

Once the difference has been adjusted for the volatility of the price, the price score in units of standards deviations may be calculated according to exemplary formula (2) shown below. In other embodiments, the parameters of formula (2) may be adjusted or tuned to meet the needs of the system 100.

current price score=−0.5 tan h(0.4*(current price SD+1))−1 (2)

By calculating the current price score in this manner, the current price score is higher when the price of the offer is lower, and lower when the price of the offer is higher. However, the current price score never reaches 0 or 1. This ensures that the current price score remains sensitive to a difference between the current market price reference and the price of the offer irrespective of the size of the difference.

A future market price reference is a prediction of what the price of the product will be at a date in the future. The system 100 may generate one or more future market price references and each future market price reference may be generated using a different method. For example, one of the future market price references may be generated through the use of trending from historical data. A future price score is generated for each future market price reference and then a total future price score is generated by weighting the various future price scores. In some cases a future price score for a date closer to the present is given more weight, and thus is more influential, than a future price for a date further away from the present. The future price scores may be generated in the same manner as the current price score. Specifically, the future price scores may be generated in accordance with formulas (1) and (2) shown above.

The component score for the price of the offer is generated from the combination of the current price score and the total future price score. In some cases, the current price score and the total future price score are given equal weight in calculating the component score for the price of the offer. In other cases, they are given different weights. The determination of the weights of the two scores will be based on the specific facts at hand. For example, a product that is needed on an urgent basis may have the current price score weighted higher.

Referring again to FIG. 2, the information source reliability component score module 210 generates a component score for the reliability of the source of the offer. The component score for the reliability of the source indicates the general reliability of the source of the offer and allows the rating system 100 to be more reliable before enough community feedback information is available to validate the offer. Typically the component score for the reliability of a particular source will be higher when positive community feedback events occur in relation to offers from that particular source and will be lower when negative community feedback events occur in relation to offers from that particular source.

As described above, the information source database 114 is used to store information related to each offer source. The component score for the reliability of the source is based upon the information in the information source database 114. In one embodiment the component score for the reliability of the source is based on the number of offers the particular source has submitted and the community feedback those offers have received. The data is scaled and normalized and then used to compute the component score. For example, the component score for the reliability of the source may be calculated in accordance with equation (3) shown below where A and B are scaling factors.

source reliability score=A*log(# of offers submitted)*(positive feedback %)+B*log(total positive feedback−total negative feedback) (3)

In other embodiments, the source reliability score may be determined using other suitable reliability factors. For example, where an individual, I, submits an offer from a merchant, M, then the reliability of the merchant, M, may also be taken into account even though the source of the offer is technically the individual, I.

The community feedback component score module 212 generates a component score for the community feedback associated with the offer. As described above, community feedback is information received from users of the rating system 100 that indicates the quality of an offer. Community feedback may be an important factor in rating a product offer since humans are typically far superior to fixed algorithms at recognizing patterns (a good offer can be considered a form of pattern) and are generally accurate in aggregate.

The component score for the community feedback may be based on (i) explicit community feedback events only; (ii) implicit community feedback events only; or (ii) a combination of implicit and explicit community feedback events. As described above, explicit community feedback is direct feedback that a user provides with respect to an offer, whereas implicit feedback is indirect feedback that is gleaned from typical interactions the user has with the system 100 (e.g. via the display module 110).

To generate a component score for the community feedback, the community feedback component score module 212 retrieves the base weight of all community feedback events for the particular offer from the community feedback database 104. In some embodiments, the community feedback component score module 212 then combines or adds the base weights to generate the component score for the community feedback. In other embodiments, each base weight is frequency scaled or weighted based on the time at which the event occurred and then combined or added together to generate the component score for the community feedback. Typically, the more recently an event occurred, the more heavily it will be weighted. Conversely, the more time that has passed since the event occurred, the less weight the event is given. The effect of this is that any particular event is most influential right after it occurs, and its effect declines as times passes. When enough time passes the event becomes effectively irrelevant. For example, the frequency weights may be computed according to formula (4) shown below.

frequency weight=base weight*0.5^{elapsed time in weeks} (4)

This allows the rating system 100 to be responsive to changing market conditions. Specifically, this allows old events to have a decreased impact on the offer's rating. As conditions change, the old events will be overshadowed by new recent events.

The weight module 204 determines an appropriate weight for each of the rating components in order to determine a total rating score. The weight module 204 first divides all of the rating components into either intrinsic components or community feedback components. As described above, intrinsic components are those components that relate only to the offer itself and the marketing conditions surrounding the offer. Examples of intrinsic rating components include the price of the offer and the reliability of the source. Community feedback components on the other hand, are components that are based on the reactions of users to the offers. It generally takes a certain volume or amount of feedback to generate a meaningful score for community feedback components.

The intrinsic components may be individually weighted. For example, the price of the offer may be given more weight than the reliability of the source. The intrinsic components as a whole may also be weighted against the community feedback components as a whole.

In one embodiment, the intrinsic components as a whole are weighted against the community feedback components as a whole in a manner that will provide the best available rating as soon as the offer exists (and little community feedback is available) and will continue to improve as more community feedback is available. Specifically, the weight assigned to the community feedback components as a whole will be proportional to the volume or amount of community feedback. Conversely, the weight assigned to the intrinsic components as a whole will be inversely proportional to the amount or volume of community feedback for the offer.

In this manner, the intrinsic components as whole will preferably be given a 100% weighting initially when there is no community feedback information available. Then, as the amount or volume of the community feedback increases, the weight of the intrinsic components will decrease and the weight of the community feedback components will increase. Preferably there is no limit on the increase in weighting of the community feedback components. Therefore, the more community feedback, the greater weight the community feedback components as a whole will have. It is possible that with enough community feedback the intrinsic components as a whole will become insignificant. However, the weighting is preferably carried out on a continuous basis. Consequently, if no new community feedback is received and the existing community feedback events decrease in importance due to the passage of time, the total rating score will again be influenced by the intrinsic components.

In some embodiments, there may be a bonus verification score that is added to the total rating score when an offer is verified through sufficient community feedback. In this embodiment if an offer is deemed to have been verified it can achieve a total rating score that no unverified offer can attain. In this manner, verified offers can be highlighted as exceptional offers.

Referring again to FIG. 2, the total rating score module 206 determines a total rating score for the offer based on the component scores generated by the component score module 202 and the component weights generated by the weight module 204. Specifically the total rating module 206 applies each weight generated by the weight module 204 to the corresponding component score generated by the component score module 202 to generate a plurality of weighted components scores. The weighted components scores are then added together to generate a total rating score for the offer.

In some embodiments, the offer rating module 106 may also include a comparison module 214 that adjusts the total rating score generated by the total rating score module 206 based on a comparison of the total rating score to one or more total rating scores for offers of similar or comparable products. In some cases, the total rating score will be increased (indicating a better rating) when the total rating score for the offer is favourable when compared to the total rating score of an offer for similar products.

In some embodiments, the comparison module 214 executes the comparison in the following manner. First the comparison module 214 receives the offer from the community feedback database 104 and compiles a list of similar or comparable products. A similar or comparable product is a product that would be considered a replacement for the product currently being rated. More particularly, similar or comparable products are those that a consumer would purchase instead of the product being rated, not in addition to the product being rated. The determination of similar products may be accomplished using any known methods, such as collaborative filtering routines or market analysis.

Once the comparison module 214 has identified the similar products, the comparison module 214 determines an offset in reference to the market price to the product being rated. The information required to determine the offset may be obtained from the historical offer database 116. Then for each similar product, the comparison module 214 determines if the offer for that product is reliable, and if so, reduces the price of the offer by the offset amount. These offers then form the comparison offers.

For each comparison offer the comparison module 214 compares the price and total rating score of the comparison offer to the price and total rating score of the product being rated and adjusts the total rating score according to certain rules. Specifically, the total rating score of the offer being rated is left unchanged if the difference in rating scores is justified by the difference in price. The total rating score of the offer being rated is increased (which signifies a better or higher quality offer) if the comparison offer has a higher rating even after accounting for the difference in price. The total rating score of the offer being rated is decreased (which signifies a lower quality offer) if the comparison offer is rated lower than the offer being rated even after accounting for the difference in price.

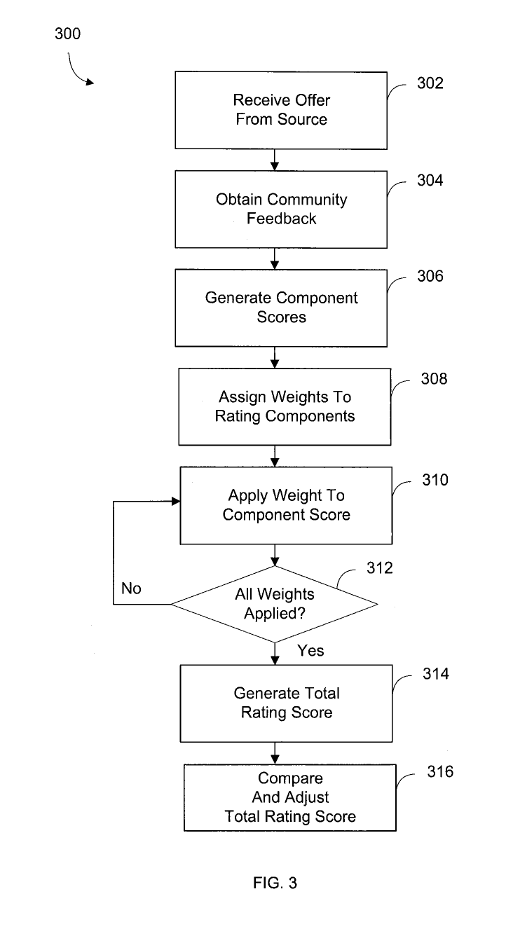

The method for rating an offer for a product according to an embodiment of the invention will now be described with reference to FIG. 3. The method 300 begins at step 302 where an offer for a product is received by the system 100 from a source (e.g. a user, operator or merchant). The offer includes a price or discount and is associated with a single product or a group of products. The offer may be input to the system 100 through an offer interface (i.e. offer interface 102) by a user or operator of the system 100 or via an electronic transfer. In some cases the received offer will be stored in a current offer database (e.g. current offer database 108) and a historical offer database (e.g. historical offer database 116).

At step 304, the system 100 obtains community feedback associated with the offer received in step 302. In certain embodiments, the community feedback is obtained from a community feedback database (e.g. community feedback database 104). As described above, community feedback is information received from users of the rating system that indicates the quality of the offer. Community feedback can be either explicit or implicit. Explicit community feedback can be described as direct feedback that a user provides with respect to an offer (e.g. explicitly rating an offer). Implicit community feedback is indirect feedback that is gleaned from normal interactions the user has with the system 100.

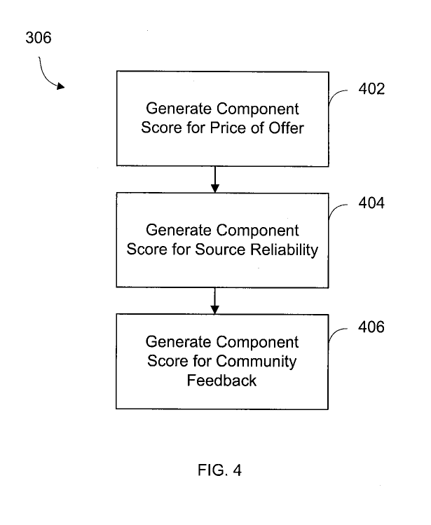

At step 306 the system 100 generates a component score for each rating component or factor. Typically, there is at least one intrinsic rating component and at least one community feedback component used to generate the total rating score for a particular offer. However, any suitable combination of intrinsic and community feedback components may be used to generate the total rating score for the particular offer. As described above in reference to the component score module 204, an intrinsic rating component is one that relates only to the offer itself and the market conditions surrounding the offer. Community feedback components, on the other hand, are components that are related to the reaction of customers to the offer. Generally the effectiveness of a community feedback component in indicating the quality of an offer is based on the volume or amount of feedback. The component scores may be generated by an offer rating module (e.g. offer rating module 106). A method for generating components scores for each rating component or factor in accordance with an embodiment will be described in more detail in relation to FIG. 4.

At step 308, a weight is assigned to each of the rating components or factors. In one embodiment, assigning a weight to each of the rating components involves first dividing all of the rating components into either intrinsic components or community feedback components. Then the intrinsic components are individually weighted. For example, where the intrinsic components include the price of the offer and the reliability of the source, the price of the offer may be given more weight than the reliability of the source. Once the intrinsic components have been individually weighted, the intrinsic components as a whole may be weighted against the community feedback components as a whole.

In one embodiment, the intrinsic components as a whole are assigned a weighting that is inversely proportional to the amount or volume of community feedback. Conversely, the weight assigned to the community feedback components will be proportional to the amount or volume of the community feedback for the offer.

At step 310, one of the weights assigned to one of the rating components in step 308 is applied to the corresponding component score generated in step 306 to generate a weighted component score. At decision diamond 312, the system 100 determines whether there are more weights to be applied to corresponding component scores. If yes, the method returns to step 310. If no, the method moves on to to step 314.

At step 314, a total rating score is generated based on the weighted components score or scores generated in step 310. In some embodiments the total rating score is the sum of the weighted component scores generated in step 310. Steps 310 through 314 may be executed by a total rating score module (e.g. total rating score module 206).

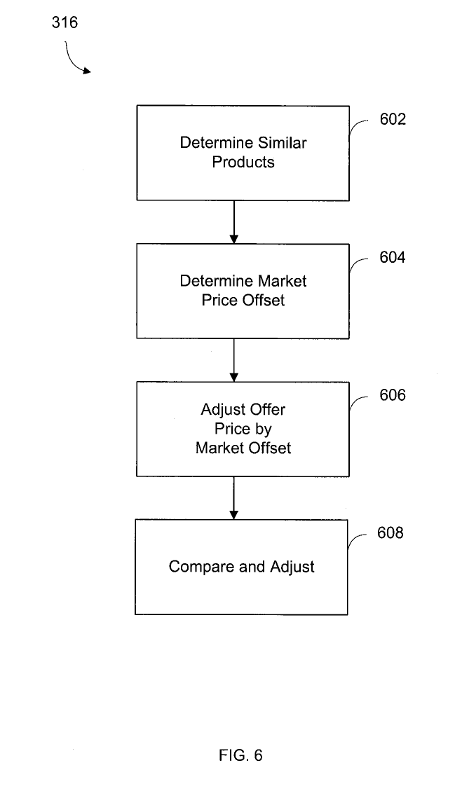

At step 316 the total rating score may be adjusted based on a comparison of the total rating score generated in step 314 with the total rating score for offers for similar or comparable products. A method for adjusting the total rating score based on a comparison of offers for similar products will described in further detail in relation to FIG. 6.

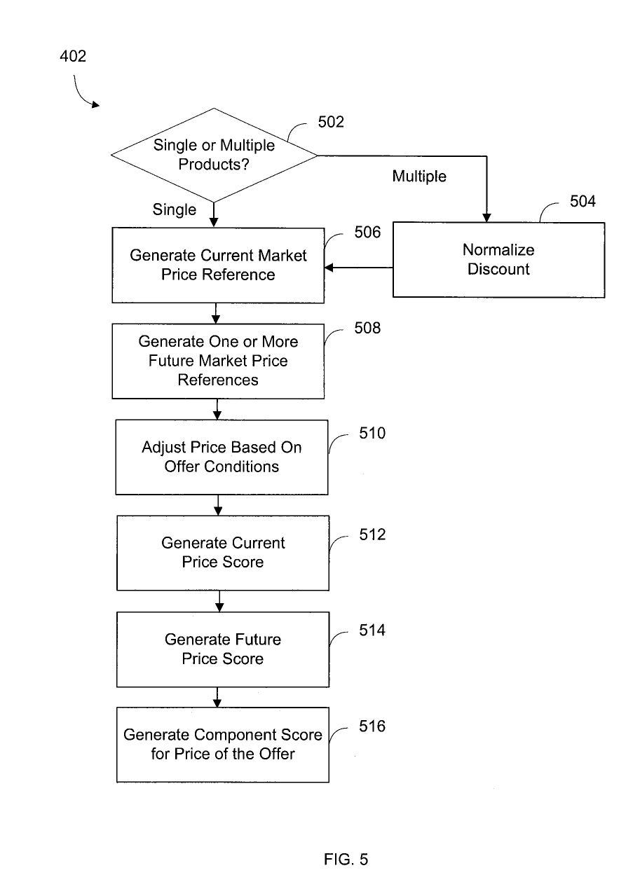

Reference is now made to FIG. 4 in which step 306 relating to generating component scores for each rating component is illustrated in further detail. In this embodiment, the rating components include the price of the offer, the reliability of the source of the offer, and community feedback. At step 402, a component score for the price of the offer is generated. This step will be described in further detail in relation to FIG. 5.

At step 404, a component score for the reliability of the source of the offer is generated. The component score for the reliability of the source indicates the general reliability of the source of the offer. In one embodiment, the component score for the reliability of the source is based on the number of offers the source has submitted and the community feedback those offers have received. For example, the component score for the reliability of the source may be calculated in accordance with equation (3) shown above where A and B are scaling factors.

At step 406, a component score for the community feedback is generated. The component score for the community feedback may be based on: (i) explicit community feedback events only; (ii) implicit community feedback events only; or (iii) a combination of implicit and explicit community feedback events.

In some embodiments, generating the component score for the community feedback includes obtaining the base weight for each community feedback event related to the offer being rated. Not all community feedback events are equal in importance in determining a rating score, so a base weight is preferably assigned to each community feedback event based on its importance in determining a rating score. Typically the higher the weight, the more reliable the community feedback event is indicating the quality of the offer.

In some embodiments, after the base weights are obtained they are added or summed to generate the component score for the community feedback. In other embodiments, after the base weights are obtained, they are frequency scaled or weighed based on the time at which the particular event occurred. Typically, the more recently an event occurred, the more heavily it will be weighted, and conversely, the more time that has passed since the event occurred, the less weight the event is given. The effect of this is that any particular event is most influential right after it occurs and its effect declines as time passes. When enough time passes the event becomes effectively irrelevant. For example, the frequency weights may be computed according to formula (4) shown above. The frequency weighting allows the rating system to be responsive to changing market conditions. Once the frequency weights are generated, they are added or summed to generate the component score for the community feedback.

Reference is now made to FIG. 5 in which step 402 relating to generating a component score for the price of the offer is illustrated in further detail. At decision diamond 502, it is determined whether the offer applies to multiple products. If yes, then the method 402 proceeds to step 504. If no, then the method 402 proceeds to step 506.

At step 504, the discount associated with the offer is normalized to produce a price (or numerical value to be used as the price) which can be used in all further calculations. Where an offer relates to multiple products, the offer typically does not have a related price, but instead has a related discount. Since there are many types of discounts, the discount has to be first normalized before it can be compared with other offers. In one embodiment, the normalization process involves converting each discount into an equivalent percentage discount (also referred to as “percentage off”) using typical transaction data for the merchant. For example where the discount is given in dollars, it may be converted to a percentage off using formula (5) shown below. Where the discount is given in terms of free shipping, it may be converted to a percentage off using formula (6) shown below. Where the discount is already given in terms of a percentage off there is no need for a conversion.

$$\begin{matrix}percentage off = \frac{dollars off}{max ( typical transaction , minimum purchase )} & ( 5 ) \\ percentage off = \frac{typical shipping costs}{max ( typical transaction , minimum purchase )} & ( 6 )\end{matrix}$$

Once the discount has been normalized to a percentage off value, the percentage off value can be used as a price for all further calculations.

At step 506, a current market price reference is generated for the product. In some embodiments, the current market price reference is based on the following information: (i) the prices for past-completed transactions for the same or similar product; (ii) the average lowest available price for the product in the past; and (iii) the current lowest available price for the product. In some embodiments, the current market price reference may be augmented by community feedback information. For example, the system 100 may include means for users or consumers to input their opinion on what a fair price for the product is. This data can be used in aggregate with the other factors to determine the current market price reference.

At step 508, one or more future market price references are generated for the product. A future market price reference is a prediction of what the price of the product will be in the future. The one or more future market price references may be generated through the use of trending from historical data or other similar methods.

At step 510, the price of the offer may be adjusted based on the offer conditions. Specifically the price may be adjusted to account for known product conditions that would affect its market value. For example, if it is known that the product offered is refurbished or used, then the price would be adjusted to bring it onto a fair playing field with new products. This type of adjustment can be made for a variety of conditions and circumstances, such as used products and delivery conditions.

At step 512, a current price score is generated for the offer. The current price score is a numerical representation of the difference between the price of the offer and the current market price reference generated in step 506. In one embodiment, the current price score is generated by determining the difference between the price of the offer and the current market price reference, adjusting the difference to account for the volatility of the price, and then converting the adjusted difference to standard deviation units. Specifically, the difference may be adjusted to account for the volatility of the price of the product according to formula (1) shown above and the price score in units of standard deviations may be calculated according to formula (2) shown above.

By calculating the current price score in this manner, the current price score is higher when the price of the offer is lower, and lower when the price of the offer is higher. However, the current price score never reaches 0 or 1. This ensures that the current price score remains sensitive to a difference between the current market price reference and the price of the offer irrespective of the size of the difference.

At step 514, a total future price score is generated for the offer. One future price score is generated for each of the future market price references generated in step 508. The total future price score is generated by weighting the various future price scores. In some embodiments, the future price scores associated with a price closer to the present is given more weight, and thus is more influential, than a future price score associated with a price further away from the present in time. Each future price score is a numerical representation of the difference between the price of the offer and one future market price reference generated in step 508 and may be generated in the same manner as the current price score in step 512. Specifically, the future price scores may be generated in accordance with formulas (1) and (2) shown above.

At step 516, the component score for the price of the offer is generated from the current price score and the total future price scores generated in steps 512 and 514 respectively. In some cases the current price score and the total future price score are given equal weight in calculating the component score for the price of the offer. In other cases they are given different weights. The determination of the weights of the two scores may be based on the facts specific to a particular offer. For example, a product that is needed on an urgent basis may have the current price score weighted higher.

Reference is now made to FIG. 6 in which step 316 relating to adjusting a total rating score based on offers for similar products is illustrated in more detail. At step 602, a list of similar or comparable products to the product being rated is complied. Similar or comparable products are products that would be considered a replacement for the product currently being rated. More particularly, the similar or comparable products are those that a consumer would purchase instead of the product being rated, not in addition to the product being rated. The compilation of similar products may be accomplished using any known methods such as collaborative filter routines or market analysis.

At step 604, an offset in reference to the market price to the product being rated is generated.

At step 606, for each similar product, it is determined whether the offer for the similar product is reliable and if so, the price of the similar offer is reduced by the offset amount calculated in step 604. These offers then form the comparison offers.

At step 608, for each comparison offer, the price and total rating score of the comparison offer is compared to the price and total rating score of the product being rated and the rating score of the product being rated is adjusted according to certain rules. Specifically, the total rating score of the offer being rated is unchanged if the difference in rating scores is justified by the difference in price. The total rating score of the offer being rated is increased if the comparison offer has a higher rating even after accounting for the difference in price. The total rating score of the offer being rated is decreased if the comparison offer is rated lower than the offer being rated even after accounting for the difference in price.

The methods and systems described herein may be suitable for use in a personal shopping web application. In such an application, a number of offers for different products may be presented to the user along with the total rating score. The total rating scores would aid the user in making their purchase decision by indicating which offer represents the best offer for the user.

The methods and systems described herein may also be suitable for use in a mobile personal shopping assistant application. In such an application, a user would be able to input information about the product they wish to purchase anywhere and at any time using their mobile device. The application would then provide the user with a total rating score for the offer. Similar to the personal shopping web application, the total rating score would aid the user in making their purchase decision by indicating whether the offer represents the best option for them.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method for rating an offer for a product, the method comprising:
a) receiving the offer from a source;
b) obtaining community feedback associated with the offer;
c) generating a component score for each rating component of a plurality of rating components, the plurality of rating components comprising at least one intrinsic component and at least one community feedback component;
d) assigning a weight to each of the plurality of rating components, the weight assigned to the at least one community feedback component being proportional to the volume of community feedback and the weight assigned to the at least one intrinsic component being inversely proportional to the volume of community feedback;
e) applying the weight of one of the rating components to the corresponding component score to generate a weighted component score;
f) repeating step (e) for at least a portion of the plurality of rating components; and
g) generating a total rating score based on the weighted component scores.

2. The method of claim 1 wherein the at least one intrinsic component comprises a price of the offer, and generating the component score for the price of the offer comprises comparing the price of the offer to: (i) a current market price reference for the product; and (ii) at least one future market price reference for the product.

3. The method of claim 2 wherein, generating the component score for the price of the offer further comprises generating a current price score and a future price score.

4. The method of claim 3, wherein generating the current price score comprises comparing the price of the offer to the current market price reference for the product.

5. The method of claim 3, wherein generating the future price score comprises comparing the price of the offer with the at least one future market price reference for the product.

6. The method of claim 2 wherein the current market price reference is based on the community feedback associated with the offer.

7. The method of claim 2 wherein step c) further comprises:
(i) determining whether the product comprises a first product and a second product; and
(ii) if (i) is true, normalizing a discount associated with the offer to produce the price of the offer.

8. The method of claim 2 wherein the at least one intrinsic component further comprises reliability of the source.

9. The method of claim 1 wherein the at least one community feedback component comprises at least one of an explicit community feedback component and an implicit community feedback component.

10. The method of claim 9 wherein the at least one community feedback component comprises at least one explicit community feedback component and at least one implicit community feedback component.

11. The method of claim 1 wherein the component score for the at least one community feedback component is based on a plurality of community feedback events, wherein the more recent a particular community feedback event, the more weight is given to the particular community feedback event.

12. The method of claim 1 further comprising:
h) obtaining an other total rating score, the other total rating score being associated with an other product;
i) comparing the total rating score with the other total rating score when the product is comparable to the other product; and
j) adjusting the total rating score based on the comparison in step (i).

13. The method of claim 1 wherein a higher total rating score indicates a higher quality offer.

14. The method of claim 1 wherein the product is at least one of goods and services.

15. A system for rating an offer for a product, the system comprising:
an offer interface configured to receive the offer from a source;
a community feedback database configured to store community feedback associated with the offer;
a component score module configured to generate a component score for each rating component of a plurality of rating components, the plurality of rating components comprising at least one intrinsic component and at least one community feedback component;
a weight module configured to assign a weight to each of the plurality of rating components, the weight assigned to the at least one community feedback component being proportional to the volume of community feedback and the weight assigned to the at least one intrinsic component being inversely proportional to the volume of community feedback;
a total rating score module configured to:
(i) apply the weight of each of the rating components to the corresponding component score to generate a weighted component score, and
(ii) generate a total rating score based on the weighted component scores; and
a display module configured to display the offer and the total rating score.

16. The system of claim 15 wherein the at least one intrinsic component comprises a price of the offer, wherein the component score for the price of the offer is generated by comparing the price of the offer to: (i) a current market price reference for the product; and (ii) at least one future market price reference for the product.

17. The system of claim 16 wherein, the component score module is adapted to generate a current price score and a future price score, wherein the current price score is generated by comparing the price of the offer to the current market price reference, and the future price score is generated by comparing the price of the offer with the at least one future market price reference.

18. The system of claim 16 wherein the current market price reference is based on the community feedback associated with the offer.

19. The system of claim 16 wherein the component score module comprises a price component score module configured to determine whether the product comprises a first product and a second product and when the product comprises a first product and a second product the price component score module is adapted to normalize a discount associated with the offer to produce the price of the offer.

20. The system of claim 16 wherein the at least one intrinsic component further comprises reliability of the source.

21. The system of claim 14 wherein the at least one community feedback component comprises at least one of an explicit community feedback component and an implicit community feedback component.

22. The system of claim 21 wherein the at least one community feedback component comprises at least one explicit community feedback component and at least one implicit community feedback component.

23. The system of claim 15 wherein the component score for the at least one community feedback component is based on a plurality of community feedback events, wherein the more recent a particular community feedback event, the more weight is given to the particular community feedback event.

24. The system of claim 15 further comprising
a historical offer database for storing an other total rating score, the other total rating score being associated with an other product; and
a comparison module configured to:
compare the total rating score to the other total rating score when the product is comparable to the other product, and
adjust the total rating score based on the comparison.

25. The system of claim 15 wherein a higher total rating score indicates a higher quality offer.

26. The system of claim 15 wherein the product is at least one of goods and services.

27. A method for rating an offer for a product, the method comprising:
a) receiving the offer from a source;
b) obtaining community feedback associated with the offer;
c) generating a component score for each rating component of a plurality of rating components, the plurality of rating components comprising a price of the offer, and generating the component score for the price of the offer comprises comparing the price of the offer to a current market price reference for the product, the current market price reference being based on the community feedback;
d) assigning a weight to each of the plurality of rating components;
e) applying the weight of one of the rating components to the corresponding component score to generate a weighted component score;
f) repeating step (e) for at least a portion of the plurality of rating components; and
g) generating a total rating score based on the weighted component scores.

28. The method of claim 27 wherein the plurality of rating components comprises at least one intrinsic component and at least one community feedback component, and the weight assigned to the at least one community feedback component being proportional to the volume of community feedback and the weight assigned to the at least one intrinsic component being inversely proportional to the volume of community feedback.

29. The method of claim 28 wherein the at least one community feedback component comprises at least one of an explicit community feedback component and an implicit community feedback component.

30. The method of claim 29 wherein the at least one community feedback component comprises at least one explicit community feedback component and at least one implicit community feedback component.

31. The method of claim 28 wherein the component score for the at least one community feedback component is based on a plurality of community feedback events, wherein the more recent a particular community feedback event, the more weight is given to the particular community feedback event.

32. The method of claim 27 wherein generating the component score for the price of the offer comprises comparing the price of the offer to: (i) the current market price reference for the product; and (ii) at least one future market price reference for the product.

33. The method of claim 32 wherein, generating the component score for the price of the offer further comprises generating a current price score and a future price score.

34. The method of claim 33, wherein generating the current price score comprises comparing the price of the offer to the current market price reference for the product.

35. The method of claim 33, wherein generating the future price score comprises comparing the price of the offer with the at least one future market price reference for the product.

36. The method of claim 27 wherein step c) further comprises:
(i) determining whether the product comprises a first product and a second product; and
(ii) if (i) is true, normalizing a discount associated with the offer to produce the price of the offer.

37. The method of claim 27 wherein the plurality of rating components further comprises reliability of the source.

38. The method of claim 27 further comprising:
h) obtaining an other total rating score, the other total rating score being associated with an other product;
i) comparing the total rating score with the other total rating score when the product is comparable to the other product; and
j) adjusting the total rating score based on the comparison in step (i).

39. The method of claim 27 wherein a higher total rating score indicates a higher quality offer.

40. The method of claim 27 wherein the product is at least one of goods and services.

41. A system for rating an offer for a product, the system comprising:
an offer interface configured to receive the offer from a source;
a community feedback database configured to store community feedback associated with the offer;
a component score module configured to generate a component score for each rating component of a plurality of rating components, the plurality of rating components comprising a price of the offer, the component score module being further configured to compare the price of the offer to a current market price reference for the product, the current market price reference being based on the community feedback associated with the offer;
a weight module configured to assign a weight to each of the plurality of rating components;
a total rating score module configured to:
(i) apply the weight of each of the rating components to the corresponding component score to generate a weighted component score, and
(ii) generate a total rating score based on the weighted component scores; and
a display module configured to display the offer and the total rating score.

42. The system of claim 41 wherein the plurality of rating components comprises at least one intrinsic component and at least one community feedback component, the weight assigned to the at least one community feedback component being proportional to the volume of community feedback and the weight assigned to the at least one intrinsic component being inversely proportional to the volume of community feedback.

43. The system of claim 42 wherein the at least one community feedback component comprises at least one of an explicit community feedback component and an implicit community feedback component.

44. The system of claim 43 wherein the at least one community feedback component comprises at least one explicit community feedback component and at least one implicit community feedback component.

45. The system of claim 42 wherein the component score for the at least one community feedback component is based on a plurality of community feedback events, wherein the more recent a particular community feedback event, the more weight is given to the particular community feedback event.

46. The system of claim 41 wherein the component score for the price of the offer is generated by comparing the price of the offer to: (i) the current market price reference for the product; and (ii) at least one future market price reference for the product.

47. The system of claim 46 wherein, the component score module is adapted to generate a current price score and a future price score, wherein the current price score is generated by comparing the price of the offer to the current market price reference, and the future price score is generated by comparing the price of the offer with the at least one future market price reference.

48. The system of claim 41 wherein the component score module comprises a price component score module configured to determine whether the product comprises a first product and a second product and when the product comprises a first product and a second product the price component score module is adapted to normalize a discount associated with the offer to produce the price of the offer.

49. The system of claim 41 wherein the plurality of rating components further comprises reliability of the source.

50. The system of claim 41 further comprising
a historical offer database for storing an other total rating score, the other total rating score being associated with an other product; and
a comparison module configured to:
compare the total rating score to the other total rating score when the product is comparable to the other product, and
adjust the total rating score based on the comparison.

51. The system of claim 41 wherein a higher total rating score indicates a higher quality offer.

52. The system of claim 41 wherein the product is at least one of goods and services.
